(19) United States
(12) Patent Application Publication
(10) Pub. No.: US 2019/0210391 A1
(43) Pub. Date: Jul. 11, 2019

(54) Latex Ink Receptive Coating

(71) Applicant: Brady Worldwide, Inc., Milwaukee, WI (US)

(72) Inventor: Amitesh Saha, Milwaukee, WI (US)

(21) Appl. No.: 16/336,186

(22) PCT Filed: Sep. 22, 2017
(86) PCT No.: PCT/US17/52894

§ 371 Date: Mar. 25, 2019

Related U.S. Application Data
(60) Provisional application No. 62/399,557, filed on Sep. 26, 2016.

(51) Int. Cl. B41M 5/52; B41M 5/00; B41M 5/50; G09F 7/00; G09F 3/02

(52) U.S. Cl. CPC B41M 5/5227; B41M 5/0017; B41M 5/5218; G09F 3/02; B41M 5/5245; G09F 7/00; B41M 5/508

(57) ABSTRACT

Outdoor-durable, latex ink signage and labels are printed on a polymeric substrate, using a small-format, inkjet printer. The polymeric substrate, e.g., a PET film, is coated with a composition comprising: (A) a polymeric binder comprising: (1) a non-cationic first polymer, and (2) a cationic second polymer, (B) a pigment, (C) a crosslinker, and (D) optionally, at least one of a UV-absorber and a UV-stabilizer.

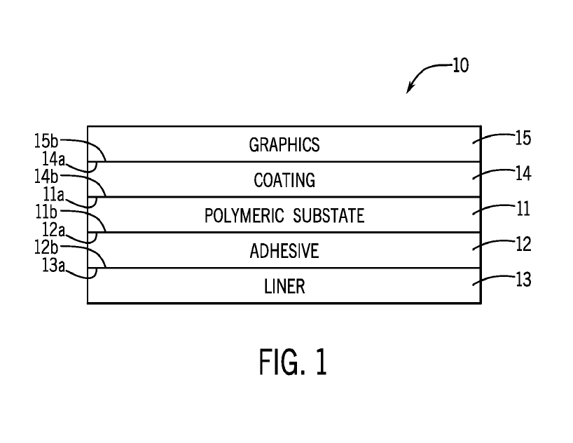

### FIELD OF THE INVENTION

This invention relates to latex ink receptive coatings. In one aspect the invention relates to the use of such coatings on polymeric substrates, aka polymeric media, while in another aspect, the invention relates to the use of such coated substrates in small-format inkjet printers to produce outdoor-durable, latex ink signage and labels.

### BACKGROUND OF THE INVENTION

Printing on polymeric media in small-format printers, i.e., printers that can print media no larger than 8 inches in width, using latex inks is practically nonexistent. This is primarily because the printing techniques traditionally used for latex inks are highly complex and employ complicated printhead technologies for spraying ink and ink adhesion aid vehicles simultaneously along with curing and heating systems to heat the substrate during and after printing. This usually results in a larger form factor for printers, i.e., the use of wide-format printers that can print media larger than 10 inches in width, which can print on uncoated polymeric media. The outdoor durability of printed signs and labels are primarily dictated by the inks.

The ability to print outdoor-durable signs and labels on polymeric media using latex ink in a small-format, inkjet printer is of interest to the print industry.

### SUMMARY OF THE INVENTION

In one embodiment the invention is a polymeric substrate coated with a composition comprising:

(A) a polymeric binder comprising:
(1) a non-cationic first polymer, and
(2) a cationic second polymer,

(B) a pigment,

(C) a crosslinker, and

(D) optionally, at least one of a UV-absorber and a UV-stabilizer.

In one embodiment the cationic second polymer of the polymeric binder is a mixture of two or more cationic polymers. In one embodiment the polymeric binder comprises 30-90 weight percent (wt %) of the total solids of the formulation from which the composition is made. In one embodiment the pigment is a mixture of two or more pigments. In one embodiment the pigment has a high porosity and specific surface area. In one embodiment the pigment comprises 10-70 wt % of the total solids of the formulation from which the composition is made. In one embodiment the crosslinker comprises 0.1-15 wt % of the composition. In one embodiment the UV-absorber and/or UV-stabilizer comprises 0-5 wt % of the composition. In one embodiment at least one of the UV-absorber and the UV-stabilizer comprises 0.01-5 wt % of the composition.

In one embodiment the invention is a method of printing a coated polymeric substrate with latex ink in a small-format, inkjet printer, the method comprising the step of applying latex ink to a coated polymeric substrate using a small-format, inkjet printer, the coating comprising:

(A) a polymeric binder comprising:
(1) a non-cationic first polymer, and
(2) a cationic second polymer,

(B) a pigment,

(C) a crosslinker, and

(D) optionally, at least one of a UV-absorber and a UV-stabilizer.

### BRIEF DESCRIPTION OF THE DRAWINGS

The Figure is a schematic drawing of a coated polymeric media.

### DETAILED DESCRIPTION OF THE PREFERRED EMBODIMENT

### Definitions

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

“Layer” means a single thickness, coating or stratum spread out or covering a surface.

“Multilayer” means at least two layers.

“Facial surface”, “planar surface” and like terms mean the flat surfaces of the layers that are in contact with the opposite and adjacent surfaces of the adjoining layers. Facial surfaces are in distinction to edge surfaces. A rectangular layer or label comprises two facial surfaces and four edge surfaces. A circular layer or label comprises two facial surfaces and one continuous edge surface.

“In contact”, “in direct contact”, “in intimate contact” and like terms mean that one facial surface of one layer and one facial surface of another layer, or the adhesive layer of a label and the exterior surface of an object or substrate to which the adhesive layer of the label is applied, are in an adhering relationship to one another without an intermediate layer, such as a coating is in an adhering relationship with the substrate to which it is applied.

“In partial contact” and like terms mean that only a part of a facial surface of a layer is in contact with a facial surface of an adjacent layer. Typically this means that the surface area of one facial surface of one layer is less than the surface area of the adjacent facial surface of another layer.

“Graphic”, “graphic image” and like terms mean text or pictorial representations formed of ink or other dye or pigments substances. Graphic images include, but are not limited to, words, numbers, bar codes, pictures, designs (geometric or otherwise), and solid colors (typically applied by flood coating).

“Composition” and like terms mean a combination of two or more materials. In the context of this invention, the coating applied to and carried on a facial surface of the polymeric substrate is a composition.

“Formulation” and like terms mean a composition comprising specific components in specific amounts. In the context of this invention, the composition from which the coating that is applied to and carried on a facial surface of the polymeric substrate is made, i.e., the mixture or blend of solids, e.g., polymeric binder, pigment, etc., and liquids, e.g., UV-absorber, UV-stabilizer, solvent, etc., is a formulation.

“Cationic polymer” and like terms mean a polymer containing a net positively-charged atom or atoms, or associated group or groups of atoms, covalently linked to its polymer molecule. Examples of positively charged atoms or groups of atoms are the ammonium, phosphonium and sulfonium cations. “Non-cationic polymer” and like terms mean a polymer that does not contain (1) a net positively-charged atom or atoms, or (2) an associated group or groups of atoms that do not contain a positive charge, covalently linked to its polymer molecule.

“Ink” and like terms mean a coatable or printable formulation that can and usually does contain a dye and/or pigment. Latex ink is usually a water-based ink.

“Pigment” and like terms mean a visible light absorbing material or compound that is present in a non-molecularly dispersed (particulate) form. In the context of this invention, the pigment (B) component of the coating applied to the polymeric substrate is inorganic particles that can absorb ink.

“Dye” and like terms mean a visible light absorbing compound that is present in a molecularly dispersed (dissolved) form.

“Outdoor-durable” and like terms means that a coating will not change color visually and exhibit resistance to weathering when exposed to outdoor conditions. This is quantified by measuring color difference (ΔE) in the coating when exposed to accelerated weathering for 2200 hours using an Atlas Ci5000 Xenon Arc Weather-O-Meter® operating on an ASTM G-155 cycle. Color difference, ΔE, is measured with a spectrodensitometer. It is defined in L, a, b color space as: ΔE=[(ΔL)²+(Δa)²⁺(Δb)²]^{1/2} where ΔE=color difference, ∧L=difference in lightness index, ∧a=difference in a value (green/red axis), and Δb=difference in b value (blue/yellow axis). ΔE of less than 5 is needed at the end of tests. 2200 hours in Weather-O-Meter correlates to about 2-3 years outdoor durability.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

### Coated Polymeric Media

The Figure illustrates one embodiment of a coated polymeric media of this invention. In the embodiment of the Figure, media 10 is a label, and it comprises polymeric substrate 11 which comprises first or top facial surface 11a and second or bottom facial surface 11b. Polymeric substrate 11 can be prepared from a wide variety of different polymers including, but not limited to, polyester, polyolefin, polyimide, polycarbonate, acrylic, and composite constructions. Typically and preferably the substrate is prepared from vinyl, polyester, particularly a polyethylene terephthalate (PET) ester or a biaxially-oriented polypropylene (BOPP) or other polyolefins (polyethylene for example) or nylon (film) or polyimide. The substrate is typically in the form of a film with a typical thickness of 0.002 inches (0.0508 mm) to 0.010 inches (0.254 mm), more typically of 0.003 inches (0.0762 mm) to 0.007 inches (0.1778 m).

Second or bottom facial surface 11b of polymeric substrate 11 is in contact with top or first facial surface 12a of optional adhesive layer 12. The composition of adhesive layer 12 can vary widely, and it includes, but is not limited to, materials comprising pressure sensitive acrylic and rubber hybrid acrylic, and rubber pressure sensitive adhesives. In one embodiment a thermoset polyester or polyurethane adhesive may be utilized. Typically and preferably, the adhesive is a pressure sensitive adhesive (PSA). The thickness of the adhesive layer typically is in the range of 0.0005 inches (0.0127 mm) to 0.003 inches (0.0762 mm), more typically of 0.0009 inches (0.02286 mm) to 0.002 inches (0.0508 mm). Adhesive layer 12 is optional to media 10. The purpose of adhesive layer 12 is to provide a means of fastening media 10 to the surface of an article or object.

Second or bottom facial surface 12b of adhesive layer 12 is in contact with top or first facial surface 13a of release liner 13. The composition of release liner 13 can also vary widely, and it is typically silicone coated to protect the adhesive until application to an article or object, e.g., a package or container, and to carry the label stock through a printer. The preferred release liner is either a film type, or a coated paper to give the adhesive a smooth surface to minimize entrapped air when bonded to the end-use surface. Release liner 13 is also optional to media 10 and is typically absent in those embodiments in which media 10 does not comprise an adhesive layer.

First or top facial surface 11a of polymeric substrate 11 is in contact with bottom or second facial surface 14b of coating 14. In one embodiment the composition of coating 14 comprises a non-cationic first polymer and a cationic second polymer. In one embodiment the non-cationic first polymer consists of, or is, a single non-cationic polymer. In one embodiment the non-cationic polymer comprises two or more non-cationic polymers. Representative non-cationic polymers include, but are not limited to, acrylic and methacrylic polymers, aliphatic urethanes, acrylic polyamides, copolymers of acrylic and urethane, polyvinyl alcohol (PVA), and the like. Representative examples of water-based acrylics include, but are not limited to, Elvacite® 2669 from Lucite International Inc.; Lubrizol's Carboset®, Hycar®, Carbobond™, Carbotac™, Hystretch™ grade of acrylic resins; PARALOID™ B-66 from Dow Chemical, and the like. Representative examples of aliphatic urethanes include, but are not limited to, K-FLEX® UD-350W, UD-320, UD-320-100, XM-386 from King Industries; SANCURE 815, 1301, 20025, and 12929 all available from Lubrizol, and the like. Selvol™ Polyvinyl Alcohol (Sekisui Chemical Co., Ltd.) is an example of PVA that can be used in the formulation. These non-cationic first polymers of the polymeric binder impart outdoor-durability and printability to the coating.

Cationic second polymers of the polymeric binder include, but are not limited to, polyvinyl pyrrolidone (PVP) and surface-modified polyurethanes. Cationically-modified polyurethane binders typically available are crosslinkable and hydrophilic, such as, WITCOBOND W-213, W-232, W-234, W-236, W-240, W-505, W-506, W-507, W-736, W-170, W-281F, W-296 and W-320 all available from Chemtura Shanghai Co. Ltd.; BAYBOND PU445 and PU 685 available from Bayer Material Science, and the like. Nonlimiting representative examples of PVP and the like are ViviPrint 530S, 540, PS-10 (Ashland Polymers), LUVITEC® K 30 and K90 (BASF). The coating contains at least one cationic polymer, preferably two or more such polymers, and these polymers assist in latex ink receptivity.

The total amount of non-cationic first polymer in the polymeric binder can vary, and is typically from 10 to 90, more typically from 20 to 50 and more typically still from 25 to 35, wt % based on the total weight of the polymeric binder. If the non-cationic first polymer comprises two or more non-cationic polymers, then the amount of each in the total amount of non-cationic first polymer in the polymeric binder can vary to convenience, e.g., from 99:1 to 1:99, or from 75:25 to 25:75, or 50:50, wt %.

The total amount of cationic second polymer in the polymeric binder can also vary, and is typically from 10 to 90, more typically from 50 to 80 and more typically still from 65 to 75, wt % based on the total weight of the polymeric binder. If the cationic second polymer comprises two or more cationic polymers, then the amount of each in the total amount of cationic second polymer in the polymeric binder can also vary to convenience, e.g., from 99:1 to 1:99, or from 75:25 to 25:75, or 50:50, wt %.

The total amount of polymer binder in the formulation from which the coating is made can vary, but is typically from 30 to 90, or from 50 to 85, or from 60 to 80, weight percent (wt %) based on the total weight of solids in the formulation.

Coating 14 also comprises one or more pigments such as, but not limited to, silica, calcium carbonate, titanium dioxide, kaolin, and various silicates. Silica is a preferred pigment. A mixture of mesoporous silica and fumed silica is particularly preferred. Mesoporous silica aids in fast ink absorption. Fumed silica has fractal morphology. It consists of primarily of particles of size 10-20 nanometers (nm) fused together irreversibly in 3-D space to give this shape with a size in the range of 200 nm to 300 nm. It also has a high specific surface area, e.g., in the range of 50 to 600 square meters per gram (m²/g). One of the advantages provided by the shape of fumed silica particles is that they can form a network by interconnecting within the binder matrix post-curing which provides good strength and hence more abrasion resisting characteristics. Because of its high aspect ratio less fumed silica is required for reaching percolation which also helps in viscosity control. In combination, both mesoporous silica and fumed silica aid a more efficient latex ink receptivity and ink fastness or absorption. This results in good print quality due to good ink fixation and minimal ink bleeding. When fumed silica is mixed with mesoporous silica, the the amount of each type in the total amount of silica pigment can vary to convenience, e.g., from 99:1 to 1:99, or from 75:25 to 25:75, or 50:50, wt %.

The pigments used in the practice of this invention typically have a high specific surface area of 150 m²/g to 400 m²/g as measured by ASTM C 1274-12, more typically in the range from 200 m²/g to 400 m²/g. While silica is the preferred pigment, other optional pigments include, but are not limited to titanium dioxide, calcium carbonate, kaolin and other silicates. These pigments are typically hydrophilic and microporous which enable efficient ink absorption. In one embodiment the pigment comprises a mixture of different morphologies like spherical, fractal, flakes, etc. and can have size ranging from 100 nm to 10 microns, more preferably 1 micron to 10 microns. Particle size measurement method is set forth in ASTM E2651-13. The amount of pigment in the formulation from which the coating is made can vary, but it is typically in an amount from 50 to 70, or from 15 to 50, or from 20 to 35, wt % based on the total weight of solids in the formulation. Some representative examples of silica pigments either in powder form or dispersion include but not limited to SYLOJET® C-Series, SYLOID® C803, C805, C807, C809, C812, C816, W300, W500, 72 FP, 244 FP and 9005 PC all available from W. R. Grace & Co.; CAB-O-SIL fumed silica EH-5, H-5, M-5 and LM-150 from Cabot corporation; SYLYSIA 310P, 320, 350, 370, 380, 420, 430, 440, 450, 470, 530, and 550 are silica pigments available from Fuji Sylysia Chemical Ltd and the like.

Coating 14 also comprises a crosslinker in the range of 0.1 to 15, or 0.5 to 10, or 0.5 to 5, or 0.5 to 3, wt % based on total weight of solids in the formulation. Any compound that can tie the pigment and binder together to form a network for solvent resistance and mechanical strength enhancement of the coated media after cure can act as the crosslinker. Typically, the crosslinker is heat-curable. Representative crosslinkers include, but are not limited to, melamine formaldehyde resins such as CYMEL™ 385, 323, 328, 350, 373, 1171, 1172, 9370, U60 and UM-15 all available from Cytec Industries; RESIMENE™ 717 available from lneos; polyfunctional aziridine crosslinker XAMA-7 available from Bayer Material Science; and polyfunctional isocyanate-based BASONAT™ HW-100 available from BASF.

Coating 14 can optionally comprise at least one of a UV-absorber and/or a UV-stabilizer. UV-absorbers include, but are not limited to, benzophenone derivatives such as CYASORB™ UV-531, benzotriazoles such as CYASORB™ UV-5411, and triazines such as CYASORB™ UV-1164 available from Solvay. The UV-stabilizers include, but are not limited to, hindered phenols such as CYASORB™ UV-2908 and hindered amines such as CYASORB™ UV-3529, HOSTAVIN™ N30, UNIVIL™ 4050, UNIVIL™ 5050, CHIMASSORB™ UV 119, CHIMASSORB™ 944 LD, TINUVIN™ 622 LD and the like. The phosphorus-containing stabilizer compounds include phosphonites (PEPQ) and phosphites (WESTON™ 399, TNPP, P-168 and DOVERPHOS™ 9228). If present, then the amount of UV-absorber and/or UV-stabilizer is typically in an amount from 0.01 to 5, or from 0.1 to 5, or from 1 to 5, wt % based on the weight of the coating before drying or cure.

Coating 14 can include one or more additives to enhance outdoor durability. These additives include, but are not limited to, antioxidants (e.g., hindered phenolics such as IRGANOX™ 1010 made by Ciba Geigy Corp.), and surface active agents or surfactants to aid dispersion of pigments and aid wetting action of the formulation from which the coating is made. Representative non-ionic surfactants to be used for this purpose include silicon-based surfactants, fluorocarbon surfactants etc. Examples of silicon-based surfactants are SILWET L-77, L-7200, L-7280, L-7600, L-7604, L7605, and L-7608 (Momentive Performance Materials); examples of fluorocarbon surfactants are FLUORAD™ FC-4430, FC-4432, and FC-4434 (3M). Other examples of surfactant are SURFADONE™ LP-100, LP-300 (Ashland Polymers) and the like. The amount of additives in the coating can vary, but it is typically in an amount from 0.01 to 10, or from 0.1 to 8, or from 1 to 5, wt % based on the total weight of solids in the formulation from which the coating is made.

First or top facial surface 14a of coating 14 is in contact with the bottom or second facial surface of graphics layer 15. The composition of graphics layer 15 is latex ink, i.e., a water-based ink comprising of pigments, one or more polymers, typically synthetic polymers, that cure into a film upon drying (cure), typically at an elevated temperature. Latex inks are widely commercially available, and representative examples include HP 831/881 Latex Ink, Mimaki LX 100/101 Latex Ink, Ricoh AR Latex Ink, Bordeaux™ EDEN Latex ink. In an embodiment of this invention, graphics layer 15 is applied to coating 14 by means of a small-format, inkjet printer. Small-format inkjet printers, e.g., inkjet printers that cannot print media larger than about 10 inches are equipped typically with a printhead that can spray only indoor dye/pigment based, nonlatex inks. A printhead has to generate relatively large drop sizes (10 picolitres to 15 picolitres) for some latex inks or might need special design for jetting some other latex inks along with latex ink adhesion aid vehicles simultaneously. Since latex inks typically require heat to dry (cure), in one embodiment of the invention the small-format, inkjet printers are equipped with a post-print heating module to maximize ink's UV resistance and outdoor durability. In one embodiment of the invention, the small-format inkjet printers are not equipped with such a heating module.

The solvent of the coating formulation is a mixture of de-ionized water with one or more alcohols with the alcohol content in the mixture not less than 50% by weight. Due to the polar nature of the cationic second polymer of the binder, polar alcoholic solvent having a hydrocarbon moiety with at least one hydroxyl group are preferred. Suitable alcohols include hydrocarbon compounds having at least one carbon atom and at least one hydroxy group. They can have a wide range of carbon atoms and hydroxy groups. Preferably, however, the alcohol has less than 15 carbon atoms and less than 4 hydroxy groups. These alcohols may have other hetero atoms besides those contributed by the hydroxy group(s) that are primary, secondary or tertiary to the hydrocarbon moiety as their valence allows. Straight chain primary and secondary alcohols ranging from 1 to 6 carbon atoms in length, such as methanol, ethanol, n-propanol, isopropanol, n-butanol, isobutanol, and so forth, are preferred. Tertiary alcohols such as diacetone alcohol are also appropriate. Glycol ethers such as diethylene glycol monobutyl ether, ethylene glycol monobutyl ether and propylene glycol monomethyl ether (1-methoxy-2-propanol) may also be used. The solvent provides the coating formulation with the desired viscosity typically in the range of 10 to 5000, more typically in the range of 20 to 1000 and even more typically in the range of 50 to 500 centipoise (cps) as measured at 25° C. Typically the solvent is chosen so that the formulation flows easily onto the plastic media and then provides the coated media with the desired drying profile, especially when exposed to heat, e.g., 50 to 200° C., and/or vacuum, e.g., less than 0.1 megaPascals (MPa).

The media of this invention are prepared in a manner similar to media known in the art. In one illustrative method, the polymeric substrate is first prepared in any conventional manner, e.g., as a film cast or extruded, in one or more multiple layers from one or more polymeric resins, e.g., polyethylene terephthalate (PET). The substrates used in the practice of this invention are typically commercially available films. The film is then covered or coated on one facial side, again in any conventional manner, with the printable coating. The coating formulation can be applied to the media in any manner, e.g., wire wound rod, reverse roll, slot die, gravure, spraying, dipping, etc., and application of the coating is usually, but not necessarily, followed by a heat drying/curing process, e.g., exposure to a temperature of 50 to 200° C. for 1 to 10 minutes depending on the type of substrate and the desired performance of the coated media such as chemical/solvent resistance, scratch/abrasion resistance, durability, etc. The coating formulation is typically applied at a thickness of 5 to 200, more typically 10 to 100 and even more typically 20 to 50, micrometers (μm). The coating formulation is typically applied as a single layer.

After the coating is dried, an adhesive is applied in any conventional manner to the opposite facial surface of the film. The liner is then applied to the exposed surface of the adhesive layer. Of course, if the media does not comprise an adhesive, then these last two steps are eliminated. Many variations exist on this illustrative method of preparing the label construction. For example, the two or more of the described steps can be reversed or otherwise changed in sequence.

The present invention provides a method to print outdoor-durable media using latex ink in a small-format, inkjet printer using a printhead that is capable of jetting latex ink without the need of complex jetting techniques such as those used in wide-format, inkjet printers, e.g., multiple printheads, auxiliary spray systems, etc. The coating layer is porous due in part at least to the porosity of the pigments and the polymeric binder matrix which allows for effective and efficient absorption of the latex ink. The coating is also effective and efficient at binding the latex ink to the polymeric substrate due, again in part at least, to the polymeric components of the coating, which in turn produces printed material that exhibits excellent outdoor durability.

One hallmark feature of this invention is that it couples an outdoor-durable, latex ink receptive coating with a noncomplex printing mechanism in small format. The coating ensures ink receptivity to the substrate because of the porosity of mostly the pigment (typically the pigment is mesoporous (e.g., pores with a diameter of 2 to 50 nanometers)) and binder matrix to some extent the cationic polymers assist in ink fixation (without any other aid), and the outdoor durability of the coating formulation is attributed to the durable polymer resin chemistry and the UV-absorbers and/or UV-stabilizers. Current aqueous inkjet receptive coatings are not designed for producing outdoor-durable products, e.g., signs, labels, etc., which means that such durability can only be achieved by printing on uncoated substrates using solvent based or UV-inks in wide format printers. The instant invention solves this problem by taking advantage of outdoor durable latex ink being sprayed from a thermal printhead compatible with latex ink in a desktop printer and a porous latex ink receptive outdoor durable coating.

The outdoor-durable coated media can also be used in wide-format printers which use latex ink or solvent based inks. This media can also be used in other small-format printers, i.e., small-format printers other than inkjet printers, which use indoor-durable water based inks. However, although such printed media will exhibit no visible change to the coating (no or little fading), the ink will fade over time.

1. A polymeric substrate coated with a composition comprising:
(A) a polymeric binder comprising:
(1) a non-cationic first polymer, and
(2) a cationic second polymer,
(B) a pigment,
(C) a crosslinker, and
(D) optionally, at least one of a UV-absorber and a UV-stabilizer.

2. The polymeric substrate of claim 1 in which the cationic second polymer of the polymeric binder comprises two or more cationic polymers.

3. The polymeric substrate of claim 1 in which the composition is made from a formulation in which the polymeric binder comprises from 30 to 90 wt %, the pigment comprises from 5 to 70 wt %, and the crosslinker comprises from 0.1 to 15 wt %, each of the wt % based on the total solids content of the formulation.

4. The polymeric substrate of claim 1 in which the non-cationic first polymer of the polymeric binder is at least one of an acrylic or methacrylic polymer, an aliphatic urethane, an acrylic polyamide, a copolymer of acrylic and urethane, and polyvinyl alcohol (PVA), and (ii) the cationic second polymer of the polymeric binder is at least one of polyvinyl pyrrolidone (PVP), and a surface-modified polyurethane.

5. The polymeric substrate of claim 1 in which the pigment of the composition has an average particle size of 500 nanometers to 10 microns and a specific surface area of 200 m²/g to 400 m²/g.

6. The polymeric substrate of claim 1 in which the pigment of the composition is at least one of silica, calcium carbonate, titanium dioxide, kaolin, and a silicate.

7. The polymeric substrate of any of claim 1 in which the composition comprises both an UV-absorber and an UV-stabilizer.

8. The polymeric substrate of claim 1 in which the composition further comprises one or more additives.

9. The polymeric substrate of claim 1 in which the substrate comprises one or more of polyvinyl chloride, polyester, polyolefin, polyimide, polycarbonate, and acrylic.

10. The polymeric substrate of claim 1 further comprising a graphic of latex ink in contact with the composition.

11. An outdoor-durable sign or label comprising the polymeric substrate of claim 1.

12. The outdoor-durable sign or label of claim 11 printed with a small-format, inkjet printer.

13. A method of printing a coated polymeric substrate with a latex ink in a small-format, inkjet printer, the method comprising the step of applying a latex ink to a coated polymeric substrate using a small-format inkjet printer, the coating comprising:
(A) a polymeric binder comprising:
(1) a non-cationic first polymer, and
(2) a cationic second polymer,
(B) a pigment,
(C) a crosslinker, and
(D) optionally, at least one of a UV-absorber and a UV-stabilizer.

14. The method of claim 13 in which the latex ink is dried in a post-printing step.
